(19) United States
(12) Patent Application Publication
(10) Pub. No.: US 2026/0031568 A1
(43) Pub. Date: Jan. 29, 2026

(54) ELECTRICAL CONNECTOR

(71) Applicant: Nippon Tanshi Co., Ltd., Hiratsuka-shi, Kanagawa (JP)

(72) Inventors: Shinya ENOMOTO, Kanagawa (JP); Osamu NISHIMURA, Kanagawa (JP)

(21) Appl. No.: 18/997,702

(22) PCT Filed: Jun. 26, 2023
(86) PCT No.: PCT/JP2023/023529

§ 371 Date: Jan. 22, 2025

(30) Foreign Application Priority Data
Jul. 22, 2022 (JP) 2022-117357

(51) Int. Cl. H01R 13/58; H01R 12/72

(52) U.S. Cl. CPC H01R 13/5812; H01R 12/721

(57) ABSTRACT

A connector main body is provided with a rear extension portion extending rearward from a rear part thereof and having an at least partly tubular shape so as to surround the lead wire, and the lead wire guide member is provided with a mouth in a front part thereof to receive the rear extension portion from above or below in a direction orthogonal to an insertion/extraction direction. An insertion/extraction direction locking portion and insertion/extraction direction locked portion are provided on the lead wire guide member and the rear extension portion, respectively, to engage the lead wire guide member and the rear extension portion with each other when the rear extension portion is received in the front part of the lead wire guide member.

### TECHNICAL FIELD

The present invention relates to an electrical connector, in particular to an electrical connector such as a plug and a jack having a lead wire connected thereto.

### BACKGROUND ART

An electrical connector is known that comprises a connector main body and a lead wire guide member (pressing assist member) detachably attached to the rear of the connector main body to guide the lead wire extending from the rear end of the connector main body with respect to the insertion/extraction direction. See Patent Document 1, for instance.

### PRIOR ART DOCUMENT(S)

### Patent Document(s)

Patent Document 1: JP2018-181469A

### SUMMARY OF THE INVENTION

### Task to be Accomplished by the Invention

The conventional lead wire guide member is constructed so as to guide the lead wire strictly downward or upward so that the same lead wire guide member cannot be used to lead the lead wires downward and upward as the situation requires.

A primary task of the present invention is to allow a same lead wire guide member to be used for both downward and upward lead wire routing.

### Means to Accomplish the Task

In order to accomplish this task, an aspect of the present invention provides an electrical connector (10), comprising: a connector main body (20) and a lead wire guide member (50) detachably attached to a rear part of the connector main body with respect to an inserting direction thereof to guide a lead wire (32) extending from a rear end of the connector main body, wherein the connector main body is provided with a rear extension portion (28) extending rearward from the rear part thereof and having an at least partly tubular shape so as to surround the lead wire, and the lead wire guide member is provided with a mouth (52) in a front part thereof to receive the rear extension portion from above or below in a direction orthogonal to an insertion/extraction direction, and wherein an insertion/extraction direction locking portion (56) and insertion/extraction direction locked portion (36) are provided on the lead wire guide member and the rear extension portion, respectively, to engage the lead wire guide member and the rear extension portion with each other when the rear extension portion is received in the front part of the lead wire guide member.

According to this aspect, by reversing the vertical mounting direction of the lead wire guide member to the connector main body, a same lead wire guide member can be used for both downward and upward routing of the lead wire so that two different lead wire guide members are not required to be prepared.

In the above aspect, preferably, the insertion/extraction direction locking portion and the insertion/extraction direction locked portion include opposing surfaces (37, 57) opposing each other in the insertion/extraction direction.

According to this aspect, the lead wire guide member and the rear extension portion can be reliably locked to each other in the insertion/extraction direction.

In the above aspect, preferably, the lead wire guide member includes an upper wall (50A), a left wall (50B), a right wall (50C) extending parallel to the left wall, and a rear wall (50D) joined to the rear edges of the upper wall, the left wall, and the right wall and extending substantially perpendicularly to the insertion/extraction direction, and the rear end of the rear extension portion defines, jointly with the upper wall, the left wall, the right wall, and the rear wall, a lead wire guide chamber (54) which is open at bottom.

According to this aspect, the lead wire can be guided by the lead wire guide member in a reliable manner.

In the above aspect, preferably, the upper wall is provided with a viewing window (60) that exposes the lead wire guide chamber.

According to this aspect, the operator can check the state of the lead wire in the lead wire guide chamber through the viewing window when the rear extension portion is received in the front part of the lead wire guide member.

In the above aspect, preferably, the rear extension portion includes a left wall (28C) and a right wall (28D) opposing the left wall and the right wall of the lead wire guide member, respectively, the insertion/extraction direction locking portion includes a groove (56A) or a slit (62) provided in each of the left wall and the right wall of the lead wire guide member so as to extend in a vertical direction, and the insertion/extraction direction locked portion includes a ridge (36A) provided on each of the left wall and the right wall of the rear extension portion so as to extend in the vertical direction in such a manner that the insertion/extraction direction locked portion is engaged with the insertion/extraction direction locking portion in a vertically slidable manner.

According to this aspect, the lead wire guide member and the rear extension portion can be reliably locked to each other in the insertion/extraction direction.

In the above aspect, preferably, the rear extension portion includes an upper wall (28A) opposing the upper wall of the lead wire guide member and a lower wall (28B), and the insertion/extraction direction locking portion further includes a groove (56B) formed in the upper wall of the lead wire guide member so as to extend in a lateral direction, and the insertion/extraction direction locked portion further includes a ridge (36B) provided in each of the upper wall and the lower wall of the rear extension portion so as to extend in the lateral direction.

According to this aspect, the lead wire guide member and the rear extension portion can be more reliably locked to each other in the insertion/extraction direction.

In the above aspect, preferably, the lead wire guide member and the rear extension portion are provided with a vertical direction locking portion (58) and a vertical direction locked portion (38), respectively, for locking the lead wire guide member and the rear extension portion to each other in the vertical direction when the rear extension portion is received in the front part of the lead wire guide member.

According to this aspect, the lead wire guide member and the rear extension portion can be reliably locked to each other in the vertical direction.

In the above aspect, preferably, the vertical direction locking portion includes an elastic claw provided on the lead wire guide member, and the vertical direction locked portion includes a locked surface (38) provided on the rear extension portion and configured to abut against the elastic claw.

According to this aspect, the lead wire guide member and the rear extension portion can be easily locked to each other in the vertical direction.

In the above aspect, preferably, the rear extension portion is provided with a protrusion (40) that abuts against a front end (51) of the lead wire guide member when the rear extension portion is received in the front part of the lead wire guide member.

According to this aspect, the positioning of the lead wire guide member in the front-rear direction with respect to the rear extension portion can be performed accurately.

### Effect of the Invention

The electrical connector according to an embodiment of the present invention thus allows a same lead wire guide member to be used for both downward and upward routing of the lead wire.

### BRIEF DESCRIPTION OF THE DRAWING

FIG. 1 An exploded perspective view of an electrical connector and a printed circuit board according to a first embodiment of the present invention

FIG. 2 A perspective view of the downward routing of lead wires from the electrical connector of the first embodiment as viewed from the rear

FIG. 3 An exploded perspective view of the downward routing of lead wires from the electrical connector of the first embodiment as viewed from the rear

FIG. 4 A perspective view of the upward routing of lead wires from the electrical connector of the first embodiment as viewed from the rear

FIG. 5 An exploded perspective view of the upward routing of lead wires from the electrical connector of the first embodiment as viewed from the rear

FIG. 6 A perspective view of the electrical connector of the first embodiment partly in section

FIG. 7 A perspective view of the electrical connector of the first embodiment partly in section

FIG. 8 A perspective view of a connector main body of the electrical connector of the first embodiment as viewed from above

FIG. 9 A perspective view of the connector main body of the electrical connector of the first embodiment as viewed from below

FIG. 10 A perspective view of a lead wire guide member of the electrical connector of the first embodiment as viewed from below

FIG. 11 A perspective view of the downward routing of lead wires from an electrical connector according to a second embodiment of the present invention as viewed from the rear

FIG. 12 An exploded perspective view of the downward routing of lead wires from the electrical connector of the second embodiment as viewed from the rear

FIG. 13 A perspective view of the downward routing of lead wires from an electrical connector of a third embodiment of the present invention as viewed from above

FIG. 14 A perspective view of a connector main body of an electrical connector according to a fourth embodiment of the present invention as viewed from above

FIG. 15 A perspective view of a lead wire guide member of an electrical connector according to a fifth embodiment of the present invention as viewed from below

FIG. 16 A perspective view of the downward routing of lead wires from an electrical connector according to a sixth embodiment of the present invention partly in section

FIG. 17 A perspective view of the downward routing of lead wires from the electrical connector of the sixth embodiment partly in section

FIG. 18 A side view of the downward routing of lead wires from the electrical connector of the sixth embodiment partly in section

FIG. 19 A perspective view of the upward routing of lead wires from the electrical connector of the sixth embodiment partly in section

FIG. 20 A side view of the upward routing of lead wires from the electrical connector of the sixth embodiment partly in section

### DESCRIPTION OF THE PREFERRED EMBODIMENT(S)

### First Embodiment

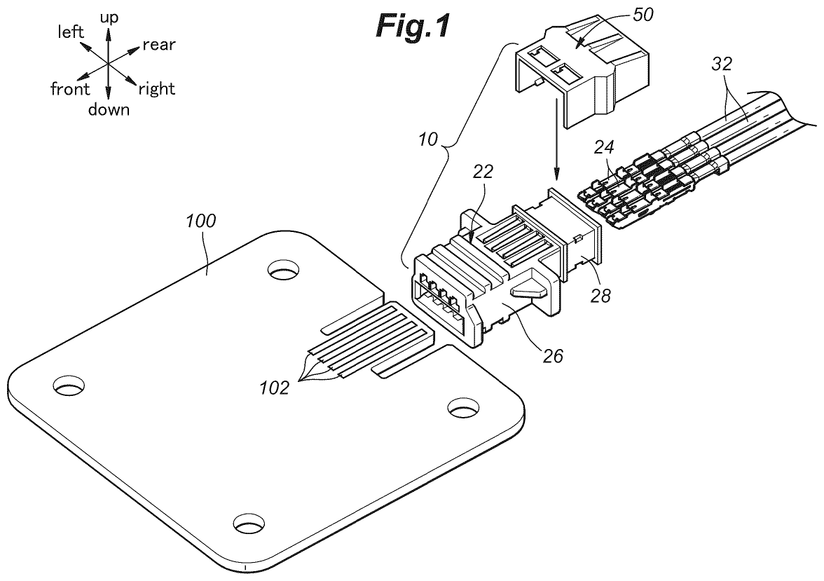

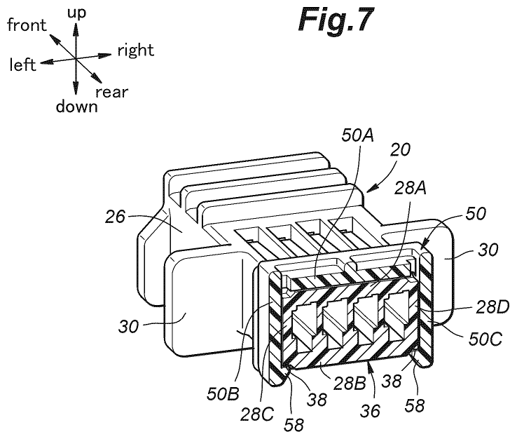

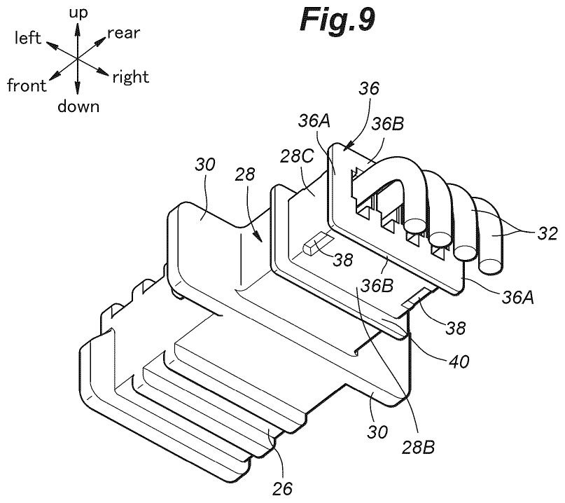

An electrical connector according to a first embodiment of the present invention will be described in the following with reference to FIGS. 1 to 10.

The electrical connector of this embodiment consists of a card edge connector 10 as shown in FIG. 1. The card edge connector 10 includes a connector main body 20 and a lead wire guide member 50 which is detachably attached to the rear part of the connector main body 20 in the insertion/extraction direction in relation to a printed circuit board (PCB) 100 to be connected. The lead wire guide member 50 guides lead wires 32 that extend rearward from the rear end of the connector main body 20 with respect to the insertion/extraction direction so as to bend.

In the following description, the insertion direction of the connector main body 20 with respect to the PCB 100 is defined as the front-back direction. However, this definition of direction is only for the convenience of explanation and does not limit the scope of the present invention.

The connector main body 20 has a rectangular tubular connector housing 22 made of a molded plastic product. The connector housing 22 is integrally formed with a terminal receiving portion 26 that receives a plurality of terminals 24 and a rear extension portion 28 that extends rearward from the rear end of the terminal receiving portion 26. The rear extension portion 28 receives therein the rear parts of the terminals 24 received in the terminal receiving portion 26. By receiving the rear parts of the terminals 24 in the rear extension portion 28, the size of the connector main body 20 can be reduced compared to the case where the rear extension portion 28 is solely configured to fit the lead wire guide member 50 thereto.

A pair of flange portions 30 are provided on either side of the terminal receiving portion 26 at a substantially middle part in the front-rear direction, and project laterally outward. The flange portions 30 are intended for the use of an operator when pushing the connector main body 20 forward into the PCB 100.

Each terminal 24 received in the terminal receiving portion 26 and the rear extension portion 28 is configured to be electrically connected to a corresponding conductive strip 102 formed on the edge of the PCB 100 at the front end thereof. Each lead wire 32 is connected to a rear part of the corresponding terminal 24. Each lead wire 32 extends rearward from the corresponding terminal 24.

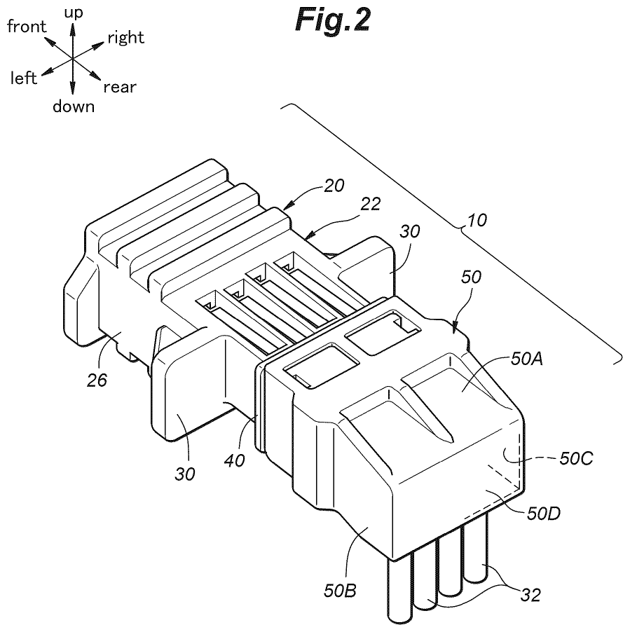

Next, details of the connector main body 20 of the first embodiment will be described in the following with reference to FIGS. 2 to 10.

The rear extension portion 28 integrally includes an upper wall 28A and a lower wall 28B that extend parallel to each other, and a left wall 28C and a right wall 28D that extend parallel to each other so as to form a rectangular tubular body that encloses the lead wires 32 as a whole.

The lead wire guide member 50 is an integrally molded member including an upper wall 50A, a left wall 50B and a right wall 50C extending parallel to each other, and a rear wall 50D joined to the rear edges of the upper wall 50A, left wall 50B, and right wall 50C.

The lead wire guide member 50 has no walls in the front and lower sides thereof, and the entire front and lower parts thereof are open. In other words, the front part of the lead wire guide member 50 opens forward, and the lower part thereof opens downward.

The front part of the lower opening of the lead wire guide member 50 is referred to as a mouth 52 for receiving the rear extension portion 28 from a vertical direction. The front parts of the upper wall 50A, the left wall 50B, and the right wall 50C of the lead wire guide member 50 oppose the upper wall 28A or the lower wall 28B, the left wall 28C, and the right wall 28D of the rear extension portion 28, respectively, when the front part of the lead wire guide member 50 receives the rear extension portion 28 therein.

In the following description, the state in which the front part of the lead wire guide member 50 receives the rear extension portion 28, or the state in which the rear extension portion 28 is received in the front part of the lead wire guide member 50 will be referred to as the received state.

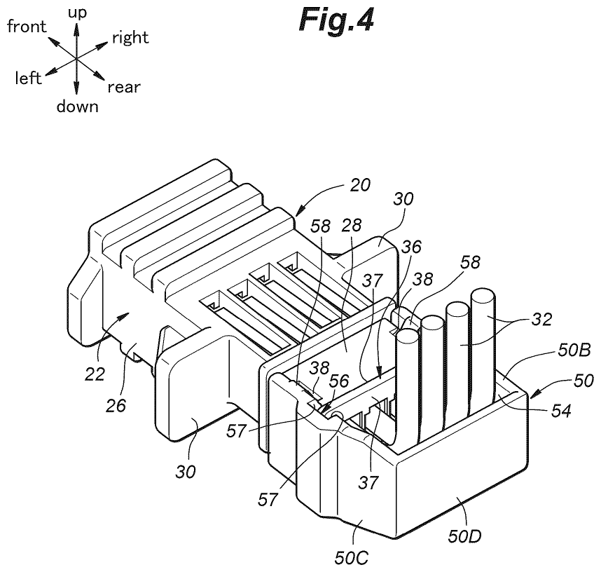

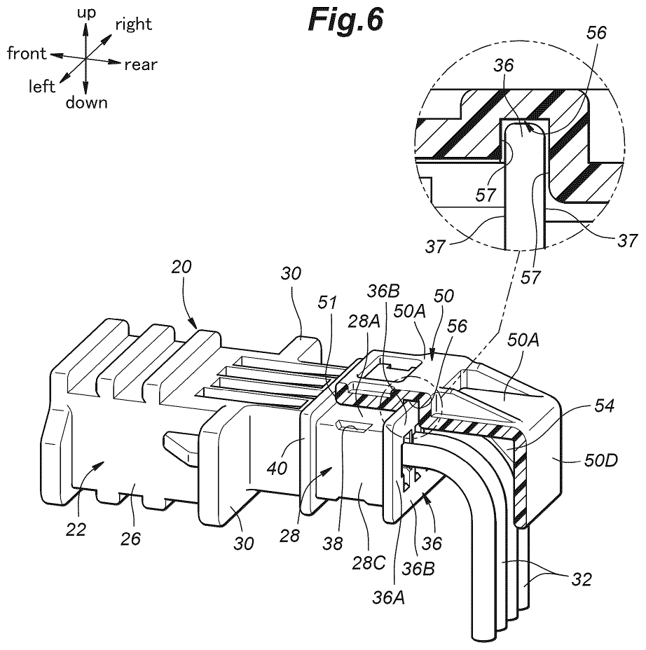

The lead wire guide member 50 may be used both for downwardly routing the lead wires 32 as shown in FIG. 2 and for upwardly routing the lead wires 32 as shown in FIG. 4. When the lead wire guide member 50 is in the state of downwardly routing the lead wires 32 as shown in FIG. 2, the upper wall 50A, the left wall 50B, the right wall 50C, and the rear wall 50D define, jointly with the rear extension portion 28, a lead wire guide chamber 54 (see FIG. 6) that is open at the bottom. When the lead wire guide member 50 is in the state of upwardly routing the lead wires 32 as shown in FIG. 4, the upper wall 50A, the left wall 50B, the right wall 50C, and the rear wall 50D define, jointly with the rear extension portion 28, a lead wire guide chamber 54 (see FIG. 6) that is open at the top.

The lead wire guide member 50 is vertically and laterally reversed between the state of upwardly routing the lead wires 32 and the state of downwardly routing the lead wires 32. As a result, the left wall 50B in the state of downwardly routing the lead wires 32 becomes the side wall positioned on the left side, and the left wall 50B in the state of upwardly routing the lead wires 32 becomes the side wall positioned on the right side.

The lead wire guide member 50 and the rear extension portion 28 are provided with an insertion/extraction direction locking portion 56 and an insertion/extraction direction locked portion 36, respectively, for engaging the lead wire guide member 50 and the rear extension portion 28 to each other in the front-back direction in the received state.

The insertion/extraction direction locking portion 56 includes a groove 56A provided on the inner surface of each of the left wall 50B and the right wall 50C of the lead wire guide member 50 so as to extend linearly and vertically, and a groove 56B provided on the inner surface of the upper wall 50A so as to extend linearly in the lateral direction. The grooves 56A extend along the left wall 50B and the right wall 50C over the entire vertical extents thereof, and are open at the lower edges of the left wall 50B and the right wall 50C. The grooves 56A and 56B are continuous with each other and have a gate shape when viewed from the front.

The insertion/extraction direction locked portion 36 includes a ridge 36A extending vertically and linearly on the outer surface of each of the left wall 28C and the right wall 28D of the rear extension portion 28 so as to vertically slidably engage the insertion/extraction direction locking portion 56, and a ridge 36B extending linearly and laterally on the outer surface of each of the upper wall 28A and lower wall 28B of the rear extension portion 28. The ridges 36A and 36B are continuous with one another and jointly form a continuous flange surrounding the rear extension portion 28, and form a rectangular frame shape when viewed from the front.

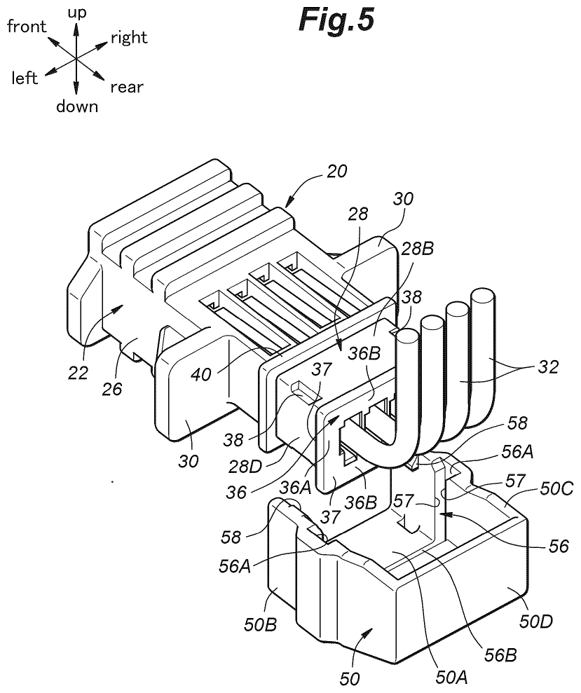

The insertion/extraction direction locking portion 56 consists of a groove having a rectangular cross-section, and the insertion/extraction direction locked portion 36 consists of a ridge having a rectangular cross-section. The front and rear surfaces of the insertion/extraction direction locking portion 56 and the insertion/extraction direction locked portions 36 form opposing surfaces 57 and 37 (see FIG. 5) that oppose each other in the front-rear direction. The opposing surfaces 57 extend over the entire front and rear surfaces of the left and right grooves 56A and the upper groove 56B of the insertion/extraction direction locking portion 56, and the opposing surfaces 37 extend over the entire front and rear surfaces of the left and right ridges 36A and the upper and lower ridges 36B of the insertion/extraction direction locked portion 36.

The lead wire guide member 50 is provided with a vertical direction locking portion 58 for locking the lead wire guide member 50 to the rear extension portion 28 with respect to the vertical direction in the received state.

The vertical direction locking portion 58 includes a pair of resilient barb-shaped claws that protrude from the inner surfaces of the left wall 50B and the right wall 50C of the lead wire guide member 50.

The vertical direction locked portion 38 includes a pair of engaged surfaces defined by a pair of engaged recesses formed in the upper wall 28A and the lower wall 28B of the rear extension portion 28 so as to be resiliently brought into contact (snap fitted) with the vertical direction locking portion 58. Hereinafter, the vertical direction locked portion 38 may also be referred to as the locked surface 38.

The rear extension portion 28 is provided with a protrusion 40 that abuts against the front edge 51 (see FIG. 6) of the lead wire guide member 50 in the received state. The protrusion 40 extends continuously on the outer surfaces of the upper wall 28A, the lower wall 28B, the left wall 28C, and the right wall 28D of the rear extension portion 28, similarly to the insertion/extraction direction locked portion 36. In other words, the protrusion 40 forms a flange surrounding the rear extension portion 28 and has a rectangular frame shape when viewed from the front.

As shown in FIG. 2, when the lead wires 32 are to be routed downward from the card edge connector 10 as shown in FIG. 2, the lead wire guide member 50 with the mouth 52 thereof facing downward is slid onto the rear extension portion 28 of the connector main body 20 vertically downward from above so that the front part of the lead wire guide member 50 is placed over the outside of the rear extension portion 28 through the mouth 52.

By moving the lead wire guide member 50 downward with respect to the rear extension portion 28 in this manner, the front part of the lead wire guide member 50 receives the rear extension portion 28 from the mouth 52 thereof in the vertical direction which is perpendicular to the insertion/extraction direction.

In this received state, the lead wires 32 extending horizontally from the rear end of the connector main body 20 in the insertion/extraction direction are bent downward by nearly 90 degrees by the lead wire guide member 50 within the lead wire guide chamber 54 so that the lead wires 32 are routed downward by the lead wire guide member 50 by being guided by the lead wire guide member 50.

When moving the lead wire guide member 50 downward with respect to the rear extension portion 28, the front edge 51 of the lead wire guide member 50 is kept in contact with the rear surface of the protrusion 40, 56, and the grooves 56A of the insertion/extraction direction locking portion 56 are slid vertically along the ridges 36A of the insertion/extraction direction locked portion 36. As a result, the downward movement of the lead wire guide member 50 relative to the rear extension portion 28 is guided by the grooves 56A and the ridges 36A. Thereby, the downward movement of the lead wire guide member 50 relative to the rear extension portion 28 can be performed smoothly and reliably.

In addition, in this received state, the insertion/extraction direction locking portion 56 and the insertion/extraction direction locked portion 36 are engaged with each other, and the lead wire guide member 50 is locked to the rear extension portion 28 in the insertion/extraction direction. In addition, in this received state, the vertical direction locking portion 58 resiliently abuts against the corresponding locked surface 38 of the lower wall 28B on both sides so that the lead wire guide member 50 is fixed to the rear extension portion 28 with respect to the vertical direction.

In this manner, in the received state, the lead wire guide member 50 is reliably prevented from being detached from the connector main body 20 with respect to both the insertion/removal direction and the vertical direction.

When the lead wires 32 are to be routed upward from the card edge connector 10 as shown in FIG. 4, the lead wire guide member 50 with the mouth 52 thereof facing upward is moved upward along the rear extension portion 28 of the connector main body 20 so that the front part of the lead wire guide member 50 is placed over the outside of the rear extension portion 28 through the mouth 52.

By moving the lead wire guide member 50 upward with respect to the rear extension portion 28 in this manner, the front part of the lead wire guide member 50 receives the rear extension portion 28 from the mouth 52 in the vertical direction which is orthogonal to the insertion/extraction direction.

In this received state, the lead wires 32 extending horizontally from the rear end of the connector main body 20 with respect to the insertion/extraction direction are bent upward by nearly 90 degrees by the lead wire guide member 50 within the lead wire guide chamber 54 so that the lead wires 32 are routed upward by the lead wire guide member 50 by being guided by the lead wire guide member 50.

When moving the lead wire guide member 50 upward relative to the rear extension portion 28, the front edge 51 of the lead wire guide member 50 is kept in contact with the rear surface of the protrusion 40, and the grooves 56A of the insertion/extraction direction locking portion 56 are moved vertically with respect to the ridges 36A of the insertion/extraction direction locked portion 36 in the vertical direction. As a result, the upward movement of the lead wire guide member 50 relative to the rear extension portion 28 is guided by the grooves 56A and the ridges 36A. This allows the lead wire guide member 50 to be moved upward relative to the rear extension portion 28 smoothly and reliably.

In this received state, the insertion/extraction direction locking portion 56 and the insertion/extraction direction locked portion 36 are engaged with each other, and the lead wire guide member 50 is locked to the rear extension portion 28 with respect to the insertion/extraction direction. Further, in this received state, the vertical direction locking portion 58 resiliently abuts against the corresponding locked surfaces 38 of the upper wall 28A on both sides so that the lead wire guide member 50 is fixed to the rear extension portion 28 with respect to the vertical direction.

In this manner, in the received state, the lead wire guide member 50 is reliably prevented from being detached from the connector main body 20 with respect to both the insertion/removal direction and the vertical direction.

As explained above, by reversing the mounting direction of the lead wire guide member 50 to the connector main body 20 downward or upward, the same lead wire guide member 50 can be used to route the lead wires 32 either downward or upward so that the need to prepare two different lead wire guide members 50 can be eliminated.

The connector main body 20 can be inserted into the PCB 100 with or without the lead wire guide member 50 attached to the connector main body 20 in advance. The process of inserting the connector main body 20 into the PCB 100 with the lead wire guide member 50 attached to the connector main body 20 can be accomplished by using a mechanical arrangement that uses the rear surface of the rear wall 50D of the lead wire guide member 50 as a pressing surface when inserting the connector main body 20 into the PCB 100.

### Second Embodiment

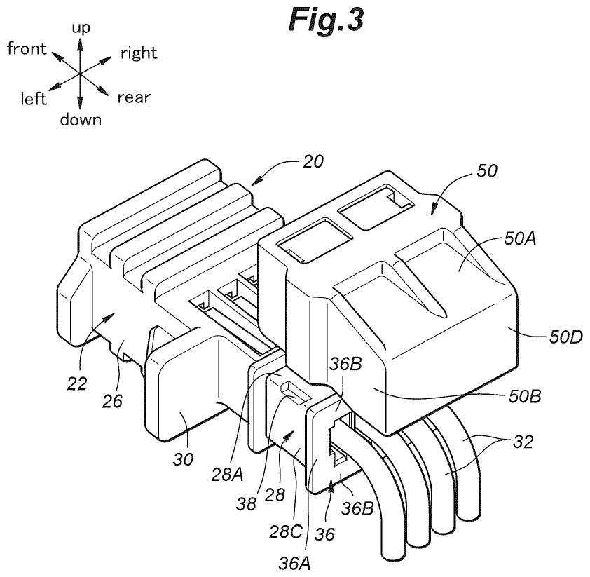

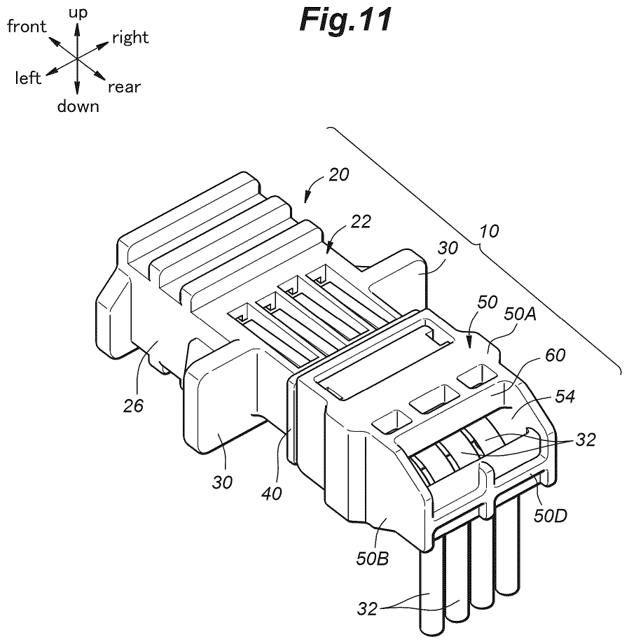

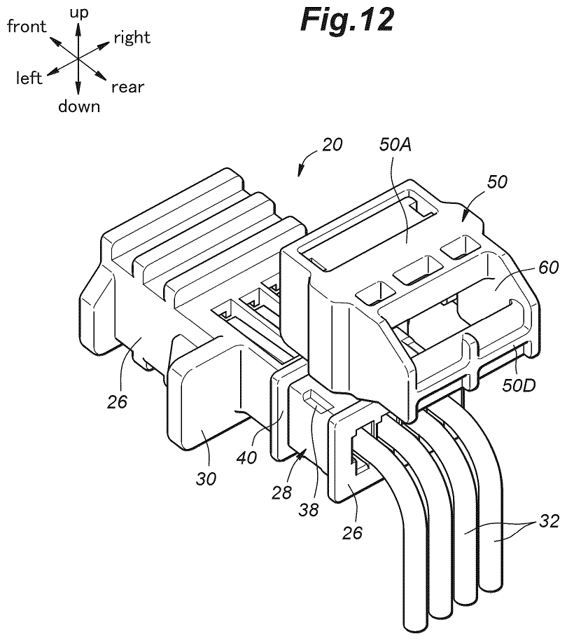

Next, details of a connector main body 20 according to a second embodiment of the present invention will be described in the following with reference to FIGS. 11 and 12. In FIGS. 11 and 12, the parts corresponding to those in FIGS. 2 and 3 are denoted with the same reference numerals as those in FIGS. 2 and 3, and the explanation of such parts may be omitted in the following description.

In the second embodiment, the upper wall 50A of the lead wire guide member 50 is provided with a viewing window 60 that opens toward the lead wire guide chamber 54 in the state where the rear extension portion 28 is received in the front portion of the lead wire guide member 50.

In the second embodiment, the operator is able to see the state of the lead wires 32 in the lead wire guide chamber 54 through the viewing window 60 even though the rear extension portion 28 is received in the front part of the lead wire guide member 50.

The second embodiment is similar to the first embodiment except for the viewing window 60, so that the same functions and effects as the first embodiment can be obtained.

### Third Embodiment

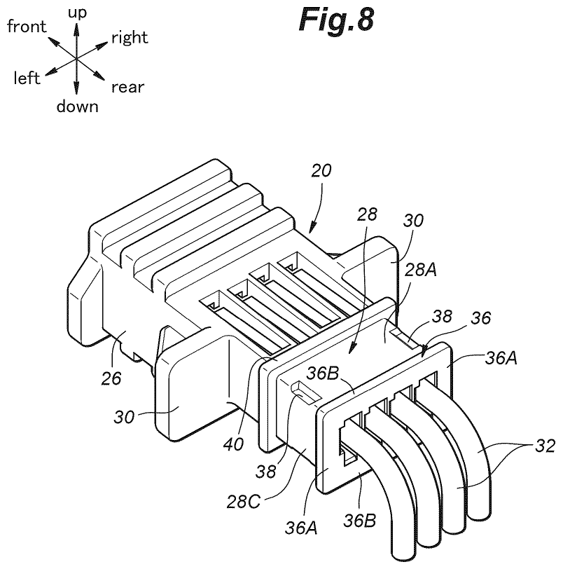

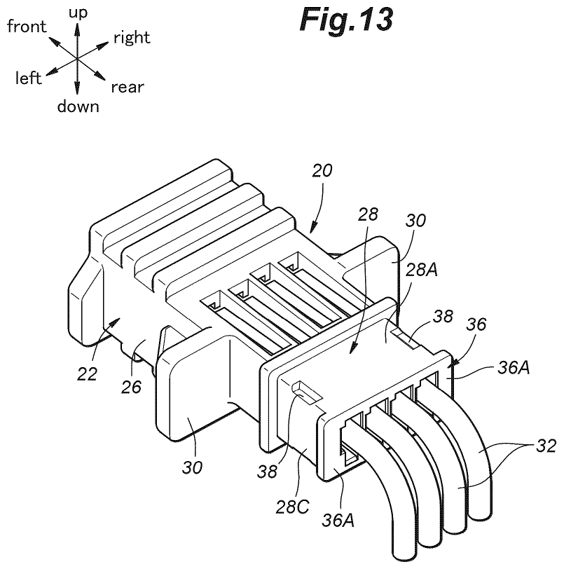

Next, details of a connector main body 20 according to a third embodiment of the present invention will be described in the following with reference to FIG. 13. In FIG. 13, parts corresponding to those in FIG. 8 are denoted with the same reference numerals as those in FIG. 8, and the description of such parts may be omitted in the following description.

In the third embodiment, the upper and lower ridges 36B are omitted, and the insertion/extraction direction locked portion 36 is formed solely by the left and right ridges 36A extending in the vertical direction.

The third embodiment demonstrates that the upper and lower ridges 36B are not essential.

The third embodiment is similar to the first embodiment except that the upper and lower ridges 36B are omitted, and provides the same functions and effects as the first embodiment.

### Fourth Embodiment

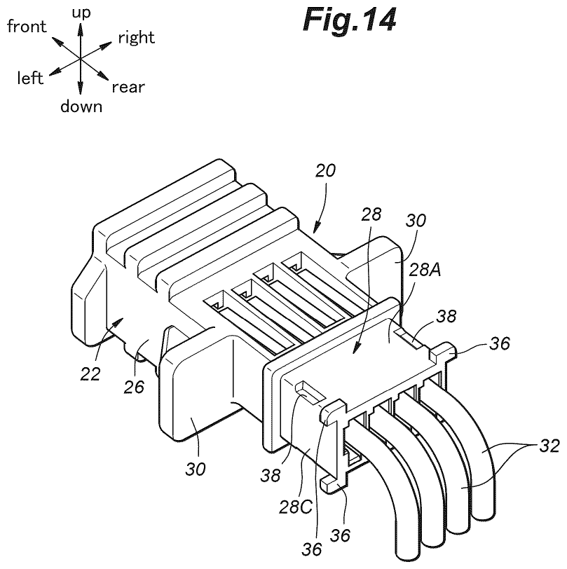

Next, details of a connector main body 20 according to a fourth embodiment of the present invention will be described in the following with reference to FIG. 14. In FIG. 14, parts corresponding to those in FIG. 8 are denoted with the same reference numerals as those in FIG. 8, and the explanation of such parts may be omitted in the following description.

In the fourth embodiment, the insertion/extraction direction locked portion 36 is formed by discrete or fragmented protrusions provided at the four corners of the rear end of the rear extension portion 28.

The fourth embodiment demonstrates that the ridges 36A, 36B of the insertion/extraction direction locked portion 36 extending over the entire lengths of the sides of the rear extension portion 28 are not essential.

The fourth embodiment is similar to the first embodiment except that the insertion/extraction direction locked portion 36 is formed by discrete ridges, and provides the same functions and effects as the first embodiment.

### Fifth Embodiment

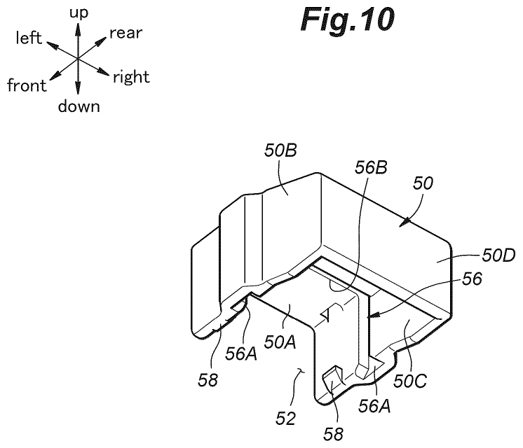

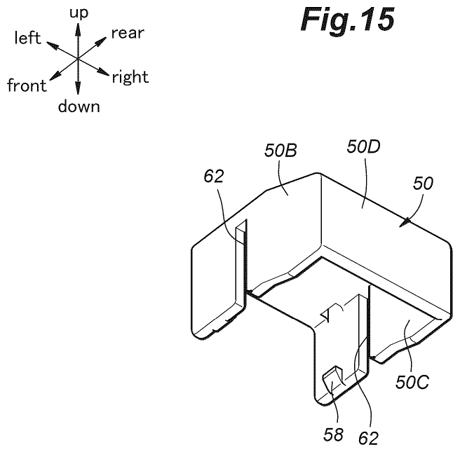

Next, details of a lead wire guide member 50 according to a fifth embodiment of the present invention will be described in the following with reference to FIG. 15. In FIG. 15, parts corresponding to those in FIG. 10 are denoted with the same reference numerals as those in FIG. 10, and the explanation of such parts may be omitted in the following description.

In the fifth embodiment, the insertion/extraction direction locking portion 56 of the lead wire guide member 50 is formed by slits 62. The slits 62 extend linearly and vertically along the inner surfaces of the left wall 50B and the right wall 50C of the lead wire guide member 50. Each slit 62 is opened at the lower edge of the left wall 50B and right wall 50C, and similarly to the grooves 56A of the first embodiment, engages the ridges 36A of the insertion/extraction direction locked portion 36 so as to be slidable in the vertical direction.

The fifth embodiment is similar to the first embodiment except that the insertion/extraction direction locking portion 56 is formed by slits 62, and provides the same functions and effects as the first embodiment.

### Sixth Embodiment

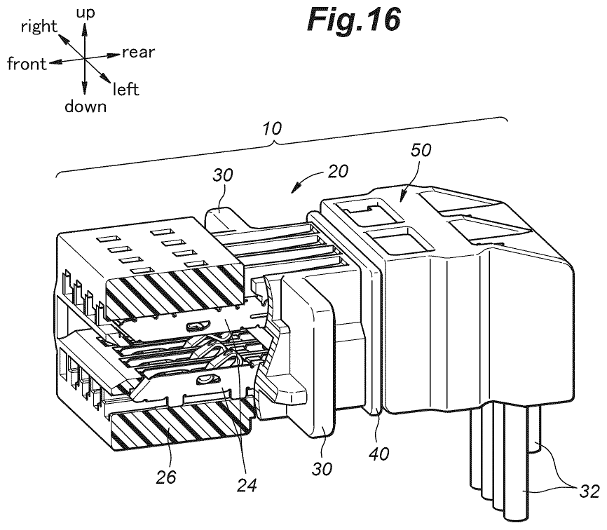

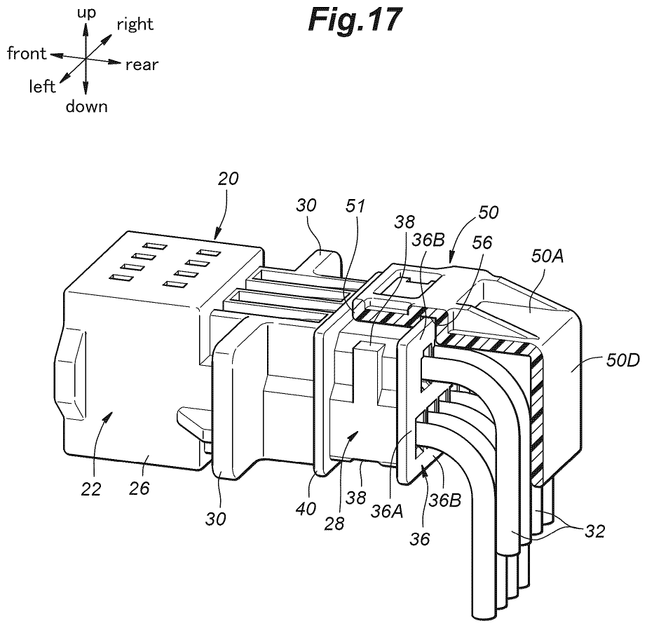

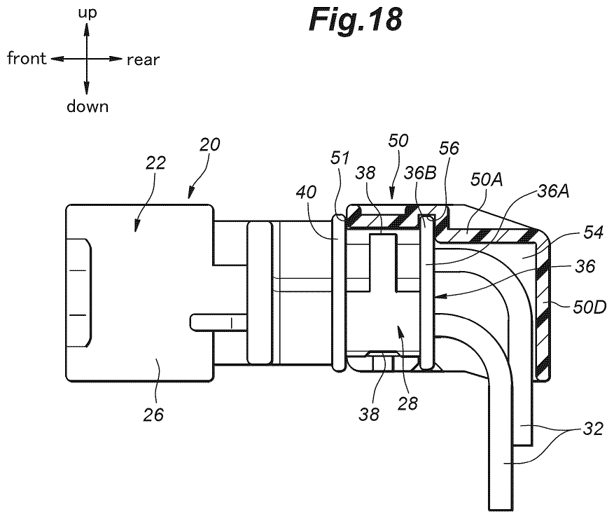

Next, details of a lead wire guide member 50 according to a sixth embodiment of the present invention will be described in the following with reference to FIGS. 16 to 20. Note that in FIGS. 16 to 20, parts corresponding to those of FIGS. 2 to 9 are denoted with the same reference numerals as those in FIGS. 2 to 9, and the description of such parts will be omitted in the following description.

In the sixth embodiment, the card edge connector 10 is intended for a double-sided printed circuit board so that the terminals 24 thereof are arranged on the connector main body 20 in two stages, upper and lower.

The sixth embodiment is similar to the first embodiment except that the insertion/extraction direction locked portion 36 is formed by discrete ridges, and provides the same functions and effects as the first embodiment.

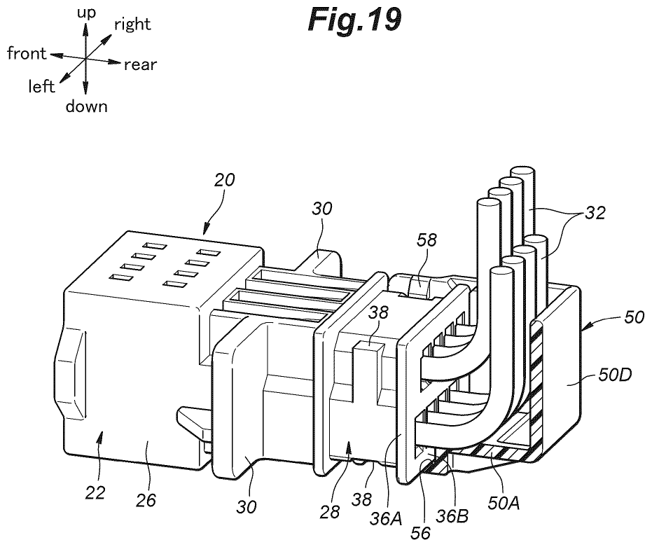

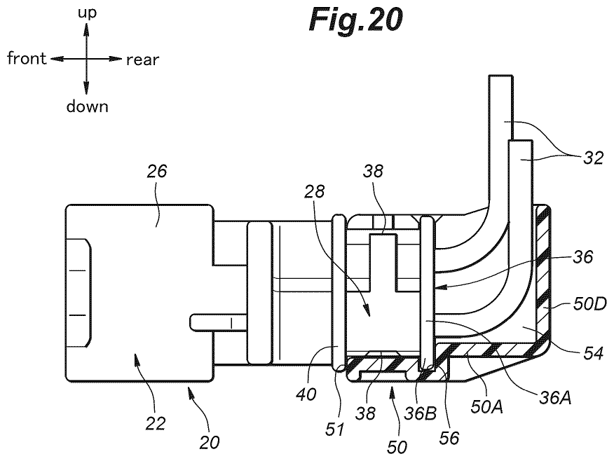

FIGS. 16 to 18 show the assembled state of the lead wire guide member 50 when the lead wires 32 are routed downward. FIGS. 19 and 20 show the assembled state of the lead wire guide member 50 when the lead wires 32 are routed upward.

Although the present invention has been described above with reference to its preferred embodiments, as will be easily understood by those skilled in the art, the present invention is not limited to such embodiments, and can be modified in various ways without departing from the scope of the present invention. It is also possible to modify the present invention such that the insertion/extraction direction locked portion 36 consists of grooves or slits while the insertion/extraction direction locking portion 56 consists of ridges. The electrical connector is not limited to a card edge connector, but may also consist of various forms of relaying connectors. Furthermore, not all of the constituent elements shown in the above embodiments are essential, and they can be substituted and omitted as appropriate without departing from the scope of the present invention.

LIST OF REFERENCE NUMERALS

| 10: card edge connector | 20: connector main body |
|---|---|
| 22: connector housing | 24: terminal |
| 26: terminal housing portion | 28: rear extension portion |
| 28A: upper wall | 28B: lower wall |
| 28C: left wall | 28D: right wall |
| 30: flange | 32: lead wire |
| 36: insertion/extraction direction locked portion | |
| 36A: ridge | 36B: ridge |
| 37: opposing surface | |
| 38: vertical direction locked portion (locked surface) | |
| 40: protrusion | 50: lead wire guide member |
| 50A: upper wall | 50B: left wall |
| 50C: right wall | 50D: rear wall |
| 51: front edge | 52: mouth |
| 54: lead wire guide chamber | |
| 56: insertion/extraction direction locking portion | |
| 56A: groove | 56B: groove |
| 57: opposing surface | |
| 58: vertical direction locking portion (elastic claw) | |
| 60: viewing window | 62: slit |
| 100: printed circuit board (PCB) | 102: conductive strip |

1. An electrical connector, comprising:
a connector main body and
a lead wire guide member detachably attached to a rear part of the connector main body with respect to an inserting direction thereof to guide a lead wire extending from a rear end of the connector main body,
wherein the connector main body is provided with a rear extension portion extending rearward from the rear part thereof and having an at least partly tubular shape so as to surround the lead wire, and the lead wire guide member is provided with a mouth in a front part thereof to receive the rear extension portion from above or below in a direction orthogonal to an insertion/extraction direction, and
wherein an insertion/extraction direction locking portion and insertion/extraction direction locked portion are provided on the lead wire guide member and the rear extension portion, respectively, to engage the lead wire guide member and the rear extension portion with each other when the rear extension portion is received in the front part of the lead wire guide member.

2. The electrical connector according to claim 1, wherein the insertion/extraction direction locking portion and the insertion/extraction direction locked portion include opposing surfaces opposing each other in the insertion/extraction direction.

3. The electrical connector according to claim 1, wherein the lead wire guide member includes an upper wall, a left wall, a right wall extending parallel to the left wall, and a rear wall joined to the rear edges of the upper wall, the left wall, and the right wall and extending substantially perpendicularly to the insertion/extraction direction, and the rear end of the rear extension portion defines, jointly with the upper wall, the left wall, the right wall, and the rear wall, a lead wire guide chamber which is open at bottom.

4. The electrical connector according to claim 3, wherein the upper wall is provided with a viewing window that exposes the lead wire guide chamber.

5. The electrical connector according to claim 3, wherein the rear extension portion includes a left wall and a right wall opposing the left wall and the right wall of the lead wire guide member, respectively,
the insertion/extraction direction locking portion includes a groove or a slit provided in each of the left wall and the right wall of the lead wire guide member so as to extend in a vertical direction, and
the insertion/extraction direction locked portion includes a ridge provided on each of the left wall and the right wall of the rear extension portion so as to extend in the vertical direction in such a manner that the insertion/extraction direction locked portion is engaged with the insertion/extraction direction locking portion in a vertically slidable manner.

6. The electrical connector according to claim 3, wherein the rear extension portion includes an upper wall opposing the upper wall of the lead wire guide member and a lower wall, and the insertion/extraction direction locking portion further includes a groove formed in the upper wall of the lead wire guide member so as to extend in a lateral direction, and the insertion/extraction direction locked portion further includes a ridge provided in each of the upper wall and the lower wall of the rear extension portion so as to extend in the lateral direction.

7. The electrical connector according to claim 3, wherein the lead wire guide member and the rear extension portion are provided with a vertical direction locking portion and a vertical direction locked portion, respectively, for locking the lead wire guide member and the rear extension portion to each other in the vertical direction when the rear extension portion is received in the front part of the lead wire guide member.

8. The electrical connector according to claim 7, wherein the vertical direction locking portion includes an elastic claw provided on the lead wire guide member, and the vertical direction locked portion includes a locked surface provided on the rear extension portion and configured to abut against the elastic claw.

9. The electrical connector according to claim 1, wherein the rear extension portion is provided with a protrusion that abuts against a front end of the lead wire guide member when the rear extension portion is received in the front part of the lead wire guide member.
